(19) United States
(12) Patent Application Publication
(10) Pub. No.: US 2008/0201874 A1
(43) Pub. Date: Aug. 28, 2008

(54) Polymer-based handicap ramping system and method of shipping and construction of same

(76) Inventors: Thomas Barth Coyle, Camano Island, WA (US); Theresa Marie Gordon, Puyallup, WA (US)

Correspondence Address: OLYMPIC PATENT WORKS PLLC, P.O. BOX 4277, SEATTLE, WA, 98104, US

(21) Appl. No.: 12/070,378

(22) Filed: Feb. 15, 2008

Related U.S. Application Data
(63) Continuation-in-part of application No. 11/405,313, filed on Apr. 17, 2006, now abandoned.

(51) Int. Cl. B65G 69/28

(52) U.S. Cl. 14/71.1

(57) ABSTRACT

Various embodiments of the present invention are directed to a ramp having certain structural properties and having polymer-based decking elements. In one embodiment of the present invention, at least one surface of the polymer-based structural member includes a number of traction ridges. The traction ridges provide a gripping surface to promote ease of motion when moving across a floor or walkway constructed from one or more polymer-based structural members.

### RELATED APPLICATIONS

This is a continuation-in-part application of Ser. No. 11/405,313, filed Apr. 17, 2006.

### TECHNICAL FIELD

The present invention relates generally to the field of providing products to aid public accommodations in providing access for disabled individuals.

### BACKGROUND OF THE INVENTION

Floors and walkways can be difficult or unsafe to move across when slippery, especially when a floor or walkway is partially obstructed or built on an incline. Both indoor and outdoor floors and walkways can become slippery when exposed to, or covered by, various substances, including water, ice, oil, grease, and other substances. Through the years, many different ways of providing traction for slippery floors and walkways have been utilized, including constructing floors and walkways from various traction-providing materials and/or laying traction-providing materials over slippery floors and walkways. However, many of these traction-providing materials are not practical for various reasons, including high price, low availability, high weight, low strength, and low durability. Additionally, in the case of outside floors and walkways, many materials cannot withstand large changes in temperature and other harsh environmental conditions without needing expensive and difficult-to-apply protective treatments, application of which may, in turn, decrease the coefficient of friction and thus contribute to the problem.

Wood, concrete, and metal, such as aluminum and galvanized steel, are relatively strong and durable building materials that are commonly used to construct floors and walkways. However, these materials are less than ideal for use in constructing non-slippery floors and/or walkways. Floors and walkways constructed from wood need to be treated with a sealer for protection from prolonged exposure to wet conditions, and/or in environments with extreme temperature changes. Wood can splinter and crack and become gouged and pitted over time. Wood can also become very slippery when wet. Floors and walkways constructed from concrete are generally non-portable, and difficult to substantially alter once a floor or walkway has been poured. Additionally, the heavy weight of concrete makes concrete difficult and expensive to use as a flooring material for some elevated floors and walkways, such as decks. Concrete can also crack and chip, and may become slick when wet or icy. Floors and walkways constructed from metal, such as aluminum and galvanized steel, can be costly to purchase and difficult to fabricate into custom shapes and intricate designs. Metal can bend, warp, scar, oxidize, and change color over time. Metal can also be dented and become slippery when wet or icy.

Traction-providing materials can be affixed to the surface of wood, concrete, or metal to increase traction. However, traction-providing materials can be difficult to securely affix to wood, concrete, and metal, and the adhesive used to affix them, as well as the traction-providing materials themselves, may deteriorate and fail over time. Contractors, carpenters, builders, craftsmen, maintenance engineers, and people who use floors and walkways have, therefore, recognized a need for a lightweight, durable, traction-providing material for constructing floors and walkways.

Moreover, the advent of the Americans with Disabilities Act and its building standards has created a challenge for many who offer public accommodations. This challenge is meeting the standards at a cost that can be funded. This burden is particularly acute for smaller organizations utilizing existing structures that do not meet the standards. Many businesses offer ramping systems that can be shipped, with instructions, to a customer. One problem with the delivery of this type of system, however, especially in an era of high and rising fuel costs, is the shipping expense, especially because of the weight of the galvanized steel deck/tread boards. Another problem is the materials cost of the ramping system itself, in an era of high aluminum and galvanized steel prices. Further, the weight of the ramp system components shipped may offer customers a challenge during installation, because heavier components will be more difficult to lift into place. Also, offering color options for aluminum and/or steel components is complicated by the fact that any surface treatment would be quickly worn away by the great amount of wear received by a typical ramp.

It is a general requirement that ramps must be strong enough to withstand a force of up to 300 lbs over a 2 in by 2 in square, for any such square on the ramp surface.

An additional problem with galvanized steel panels used to provide a walking surface in a ramp, is that of possible injuries to users. The ADA requires that elementary schools and kindergartens meet the requirements, as these institutions are public accommodations. Unfortunately, the hard steel surface, formed into gripping tread, can badly bruise and scrape a child who falls upon it.

Yet another problem with steel decking elements is the glare that is created on a sunny day. This glare is not only irritating to ramp users, it can also increase the risk of accident by reducing visibility, thereby making it more difficult to negotiate the ascent or descent across the ramp.

Some material and method of building a ramp is needed that has the strength and gripping characteristics necessary to meet the relevant requirements, but is softer and less reflective than steel or aluminum.

### SUMMARY OF THE INVENTION

Various embodiments of the present invention are directed to a ramp having certain structural properties constructed using polymer-based deck elements. In one embodiment of the present invention, at least one surface of the polymer-based structural member includes a number of traction ridges. The traction ridges provide a gripping surface to promote ease of motion when moving across a floor or walkway constructed from one or more polymer-based structural members.

### BRIEF DESCRIPTION OF THE DRAWINGS

FIG. 1 illustrates a perspective view of a slip-resistant, polymer-based plank that represents one embodiment of the present invention.

FIG. 2A illustrates an end view of the slip-resistant, polymer-based plank shown in FIG. 1 that represents one embodiment of the present invention.

FIG. 2B illustrates an end view of a slip-resistant, polymer-based plank with traction ridges on the top and the bottom that represents one embodiment of the present invention.

FIG. 3 shows an end view of a slip-resistant, polymer-based plank with non-orthogonal interior support walls that represents one embodiment of the present invention.

FIG. 4 illustrates an end view of six different traction-ridge sets that each represents a different embodiment of the present invention.

FIG. 5A illustrates a top view of a walkway that represents one embodiment of the present invention.

FIG. 5B illustrates a top view of the walkway shown in FIG. 6A with interior-mounted radiant-heat tubing that represents one embodiment of the present invention.

FIG. 6A illustrates a perspective view of a slip-resistant, polymer-based plank that represents one embodiment of the present invention.

FIG. 6B shows an interior guide that can be placed inside the slip-resistant, polymer-based plank shown in FIG. 6A and that represents one embodiment of the present invention.

FIG. 6C illustrates the interior guide shown in FIG. 6B with a tube passing through the aperture that represents one embodiment of the present invention.

FIG. 7A illustrates an end cap for a slip-resistant, polymer-based plank that represents one embodiment of the present invention.

FIG. 7B illustrates an extended end cap for a slip-resistant, polymer-based plank that represents one embodiment of the present invention.

FIG. 8A shows an end view of a slip-resistant, polymer-based sheet that represents one embodiment of the present invention.

FIG. 8B shows a perspective view of polymer-based sheet shown in FIG. 4A that represents one embodiment of the present invention.

FIG. 9A illustrates a slip-resistant, polymer-based sheet that represents one embodiment of the present invention.

FIG. 9B illustrates a ramp constructed using a number of the slip-resistant, polymer-based sheets shown in FIG. 10A and represents one embodiment of the present invention.

FIG. 10 shows a perspective view of a ramp constructed, in part, of slip resistant polymer deck elements, taken in cross-section.

FIG. 11 is a perspective view of a rectangular frame adapted to form a portion of the ramp of FIG. 10.

FIG. 12 is a cross-sectional view of a plastic board adapted to form a portion of an ADA compliant ramp, according to a preferred embodiment of the present invention.

### DETAILED DESCRIPTION OF THE INVENTION

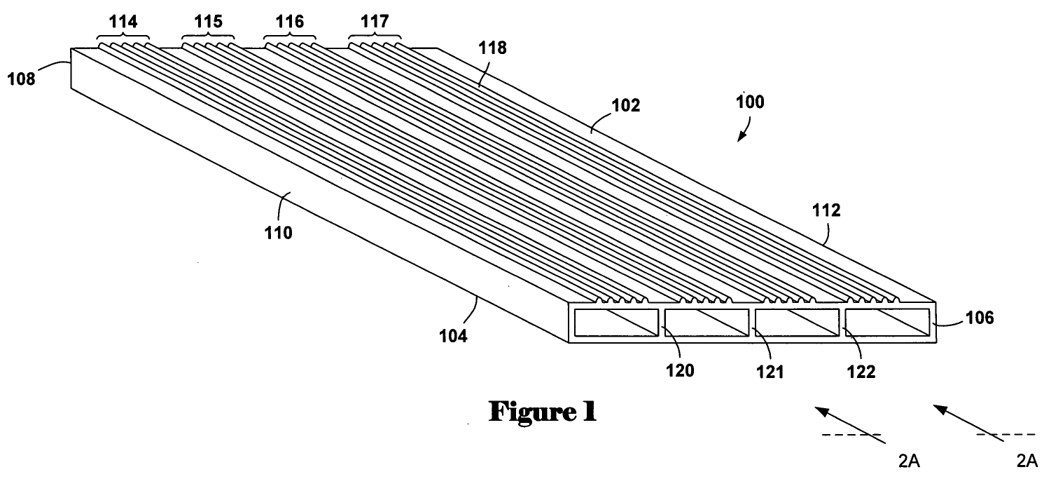

Various embodiments of the present invention are directed to a polymer-based structural member for constructing floors and walkways. In one embodiment of the present invention, a polymer is fabricated into a slip-resistant, polymer-based plank. FIG. 1 illustrates a perspective view of a slip-resistant, polymer-based plank that represents one embodiment of the present invention. Slip-resistant, polymer-based plank 100 includes a top 102, a bottom 104, a first open end 106, a second open end 108 opposite to the first open end 106, a first side 110, and a second side 112 opposite to the first side 110. Top 102 further includes four roughly evenly-spaced traction-ridge sets 114-117 extending roughly parallel to the first side 110 and the second side 112 from the first open end 106 to the second open end 108. Each traction-ridge set contains five roughly parallel traction ridges, such as traction ridge 118. Three interior support walls 120-122 extend the length of the interior of the slip-resistant, polymer-based plank 100, from the first open end 106 to the second open end 108. The traction ridges within each traction-ridge set are roughly linear and roughly parallel to the first side 112 and the second side 114.

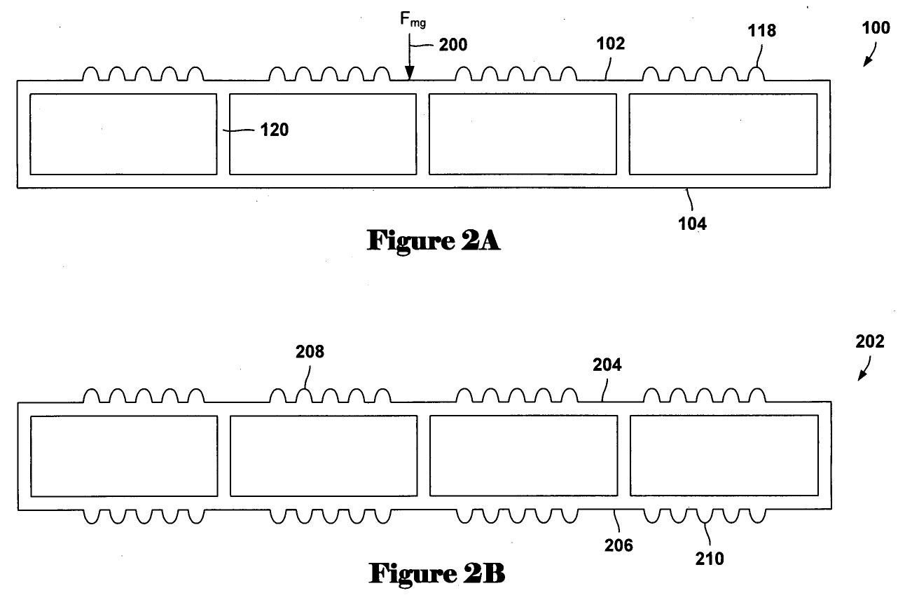

FIG. 2A illustrates an end view of the slip-resistant, polymer-based plank shown in FIG. 1 that represents one embodiment of the present invention. Interior support walls, such as interior support wall 120, provide support to withstand applied forces with vertical components, such as force vector F_{mg} 200. The number of interior support walls used for a slip-resistant, polymer-based plank can vary depending on the width of the slip-resistant, polymer-based plank and/or the desired load-bearing capacity. In alternate embodiments, the spaces between the interior support walls are filled with insulation, foam, fiberglass, or other lightweight material. In the embodiment of the present invention shown in FIG. 2A, traction ridges, such as traction ridge 118, are molded into the top 102 of the slip-resistant, polymer-based plank 100. In alternate embodiments of the present invention, traction ridges can be fabricated on two or more faces of a slip-resistant, polymer-based plank, such as a top and a bottom. FIG. 2B illustrates an end view of a slip-resistant, polymer-based plank with traction ridges on the top and the bottom that represents one embodiment of the present invention. The top 202 of the slip-resistant, polymer-based plank 202 contains a number of traction ridges, such as traction ridge 208. Similarly, the bottom 206 contains a number of traction ridges, such as the traction ridge 210. When the traction ridges on the top 204 become worn down over time, the slip-resistant, polymer-based plank 202 can be inverted to expose a fresh set of traction ridges on the opposite side. In alternate embodiments, the traction ridges on the top are different from the traction ridges on the bottom, giving the floor or walkway builder a choice of slip-resistant surfaces.

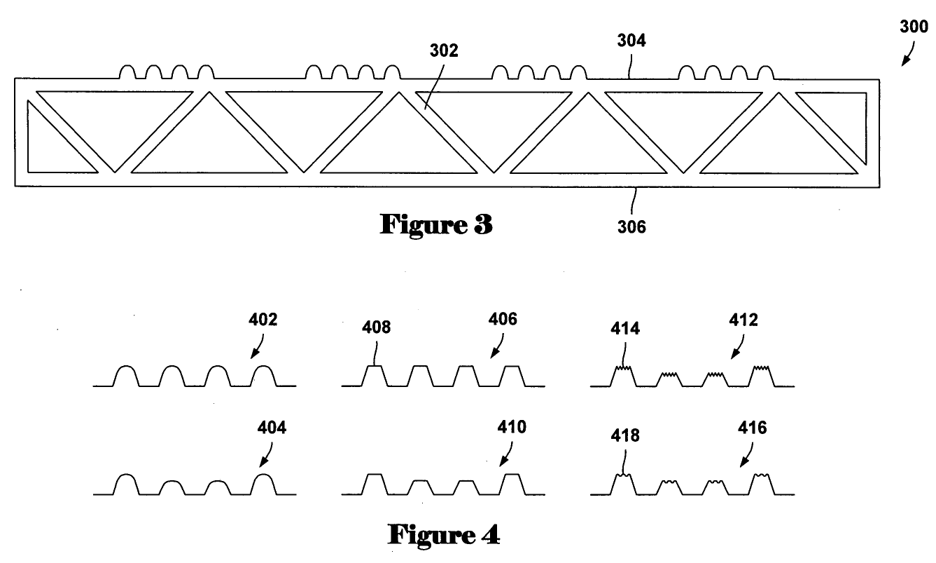

FIG. 3 shows an end view of a slip-resistant, polymer-based plank with non-orthogonal interior support walls that represents one embodiment of the present invention. Slip-resistant, polymer-based plank 300 includes a number of interior support walls, such as interior support wall 302, extending from a top 304 to a bottom 306 of slip-resistant, polymer-based plank 300 at a non-orthogonal angle. In alternate embodiments, the spaces between the non-orthogonal interior support walls and the outer walls of slip-resistant, polymer-based plank 300 are filled with insulation, foam, fiberglass, or other lightweight material. In additional alternate embodiments, a slip-resistant, polymer-based plank with non-orthogonal interior support walls includes traction ridges on two or more exterior surfaces, such as a top and a bottom.

Traction ridges can be fabricated into a variety of alternate shapes and patterns. FIG. 4 illustrates an end view of six different traction-ridge sets that each represents a different embodiment of the present invention. Traction-ridge set 402 contains four traction ridges that are rounded and are each roughly the same size. Traction-ridge set 404 contains four traction ridges that are rounded and that each has one of two sizes, with the larger-sized traction ridges flanking the smaller-sized traction ridges. Traction-ridge set 406 contains four traction ridges that are roughly trapezoidal in shape and each roughly the same size, with a flat top edge 408. Traction-ridge set 410 contains traction ridges that are roughly trapezoidal in shape, with a flat top edge, and that each has one of two sizes, with the larger-sized traction ridges flanking the smaller-sized traction ridges. Traction-ridge set 412 contains four traction ridges that are roughly trapezoidal in shape with a jagged top edge 414. Each traction ridge has one of two sizes, with the larger-sized traction ridges flanking the smaller-sized traction ridges. Traction-ridge set 416 contains four traction ridges that are roughly trapezoidal in shape with a number of indentations in the top edge 418 of each traction ridge. Each traction ridge has one of two sizes, with the larger-sized traction ridges flanking the smaller-sized traction ridges. In alternate embodiments of the traction-ridge sets containing two sizes of traction ridges 404, 410, 412, and 416, the smaller-sized traction ridges flank the larger-sized traction ridges. In yet other alternate embodiments, smaller-sized traction ridges and larger-sized traction ridges alternate.

In various alternate embodiments of the present invention, traction-ridge sets include variable numbers of traction ridges. Individual traction ridges can also be placed on a slip-resistant, polymer-based structural member. Each traction ridge within a traction-ridge set can be a different size and shape from the other traction ridges within the traction-ridge set, and traction ridges of different traction-ridge sets may differ in size and shape. Moreover, the spacing between adjacent traction ridges and adjacent traction-ridge sets can vary. Traction ridges and traction-ridge sets can be fabricated in patterns other than straight lines. For example, a slip-resistant, polymer-based structural member may contain one or more traction-ridge sets containing a number of curved traction ridges with 0, 1, or more inflection points. Traction ridges and traction-ridge sets need not extend the entire length of a slip-resistant, polymer-based support member.

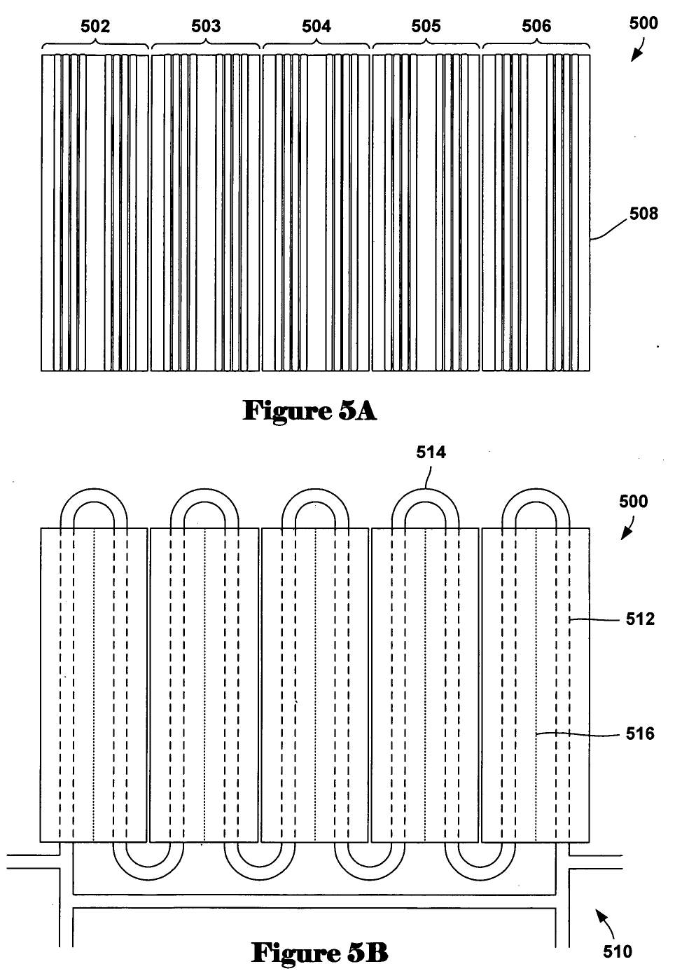

FIG. 5A illustrates a top view of a walkway that represents one embodiment of the present invention. Walkway 500 includes five abutting slip-resistant, polymer-based planks 502-506. Each slip-resistant, polymer-based plank 502-506 abuts at least one other slip-resistant, polymer-based plank along a side, such side 508. Transmission media, including pipes, conduits, tubing, and wires can extend through the interior of slip-resistant, polymer-based planks in order to provide an unobtrusive way to provide electrical wiring, plumbing, and radiant-heat tubes. Access apertures can be cut from the flat portions of the top and/or bottom of a slip-resistant, polymer-based plank to provide access to the pipes, conduits, tubes, and wires within a slip-resistant, polymer-based plank. For example, an access aperture can be cut from a slip-resistant, polymer-based plank and an electrical outlet can be placed in the access aperture to provide an electrical outlet on the floor or walkway.

FIG. 5B illustrates a top view of the walkway shown in FIG. 5A with interior-mounted radiant-heat tubing that represents one embodiment of the present invention. Walkway 500 contains a radiant heat system 510 which extends inside each of the slip-resistant, polymer-based planks comprising walkway 500. The traction-ridge sets on the exterior of the slip-resistant, polymer-based planks have been omitted for clarity. Radiant heat system 510 includes straight sections, such as straight section 512 extending along the interior length of the slip-resistant, polymer-based planks, and curved sections, such as curved section 514 bending outside the open ends of the slip-resistant, polymer-based planks. In FIG. 5B, there are two straight sections shown extending through each slip-resistant, polymer-based plank. The two straight sections of the radiant heat system 510 in a slip-resistant, polymer-based plank are separated by an interior support wall, such as interior support wall 516, shown as a dotted line.

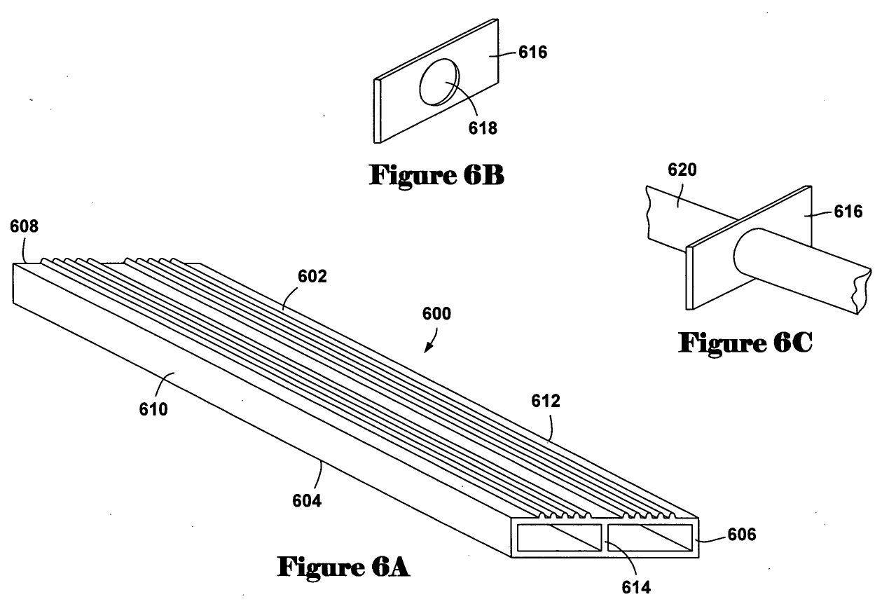

FIG. 6A illustrates a perspective view of a slip-resistant, polymer-based plank that represents one embodiment of the present invention. Slip-resistant, polymer-based plank 600 includes a top 602, a bottom 604, a first open end 606, a second open end 608, a first side 610, and a second side 612. A single interior support wall 614 separates the interior of the slip-resistant, polymer-based plank 600 into two discrete open spaces. FIG. 6B shows an interior guide that can be placed inside the slip-resistant, polymer-based plank shown in FIG. 6A and that represents one embodiment of the present invention. Interior guide 616 includes an aperture 618 through which a pipe, conduit, tube, or wire can pass. Interior guide 616 can be placed into either the first open end (606 in FIG. 6A), or the second open end (608 in FIG. 6A) of the slip-resistant, polymer-based plank (600 in FIG. 6A) with aperture 618 roughly perpendicular to interior support wall 614. Interior guide 616 is sized and shaped to fit snugly in the interior of the slip-resistant, polymer-based plank (600 in FIG. 6A), inside one of the two discrete open spaces surrounded, in part, by interior support wall (614 in FIG. 6A), top (602 in FIG. 6A), bottom (604 in FIG. 6A), and either first side (610 in FIG. 6A), or second side (612 in FIG. 6A).

FIG. 6C illustrates the interior guide shown in FIG. 6B with a tube passing through the aperture that represents one embodiment of the present invention. A section of tube 620 is shown passing through the aperture (618 in FIG. 6B) of interior guide 616. A number of interior guides can be placed within the interior spaces of a slip-resistant, polymer-based plank in either regular or irregular length intervals to prevent inserted pipes, conduits, tubes, and wires from shifting and from directly contacting the slip-resistant, polymer-based plank. The spacing between interior guides can vary depending on the flexibility of the inserted pipe, conduit, tubing, or wire. The sizes and shapes of interior guides may vary due to the differences in size and shape of a slip-resistant, polymer-based plank, and the configuration and number of interior support walls.

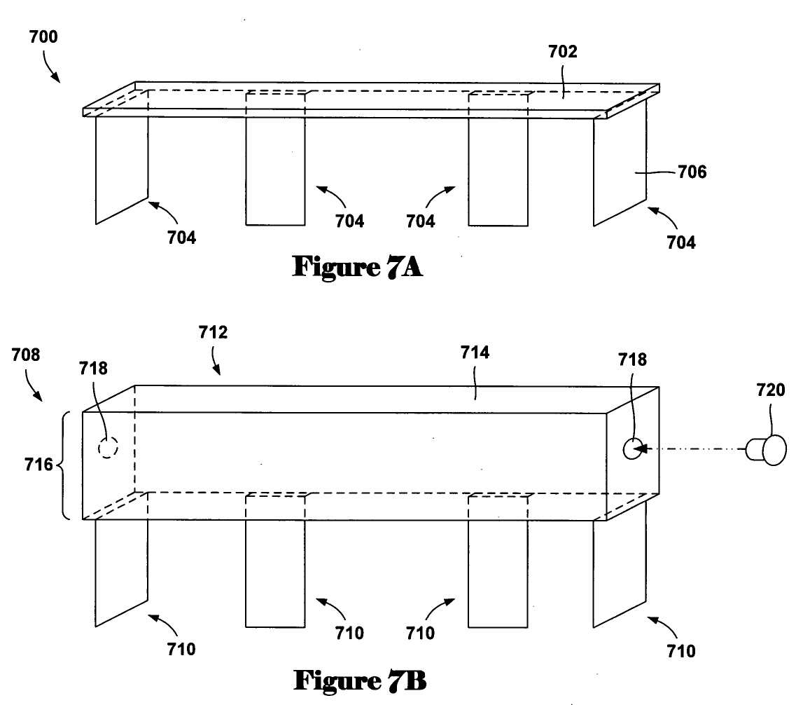

FIG. 7A illustrates an end cap for a slip-resistant, polymer-based plank that represents one embodiment of the present invention. End cap 700 includes an end face 702 and a number of insert tabs 704. End cap 700 can be constructed with an end face 702 that has similar dimensions to the open end of a single slip-resistant, polymer-based plank. In alternate embodiments, end cap 700 includes an end face 702 that has similar dimensions to the open ends of multiple slip-resistant, polymer-based planks placed end to end along a section of a floor or walkway, such as the walkway shown in FIG. 5A. Insert tabs 704 can be slid into the open ends of one or more slip-resistant, polymer-based planks until the end face 702 is flush with one or more open ends of slip-resistant, polymer-based planks. Various types of adhesive, such as PVC glue or epoxy, can be applied to the outer surface of the insert tabs 704, such as outer surface 706, to affix the insert tab 704 to the interior surfaces of one or more slip-resistant, polymer-based planks.

FIG. 7B illustrates an extended end cap for a slip-resistant, polymer-based plank that represents one embodiment of the present invention. Extended end cap 708 includes a number of insert tabs 710 and a hollow end piece 712 with an end face 714. Extended end cap 708 has similar dimensions to the open ends of one or more slip-resistant, polymer-based planks and can be used to cap the open ends of one or more slip-resistant, polymer-based planks by sliding the insert tabs 710 into the open ends of one or slip-resistant, polymer-based planks until the extended end cap 708 is flush with one or more of the open ends of the slip-resistant, polymer-based planks. Various types of adhesive can be used to affix the insert tabs 710 to one or more slip-resistant, polymer-based planks.

When an extended end cap 708 is flush with the open ends of one or more slip-resistant, polymer-based planks, end face 714 extends outward a distance 716 from the open ends of the capped slip-resistant, polymer-based planks. Distance 716 is large enough to contain and protect pipes, conduits, tubing, or wires extending out of the open ends of the capped slip-resistant, polymer-based planks, such as the curved sections (514 in FIG. 5B) of a radiant heat system (510 in FIG. 5B). Distance 716 can vary depending on how far out from the open ends of slip-resistant, polymer-based planks the pipes, conduits, tubing, or wires extend. Extended end cap 708 further includes end apertures 716 which provide an entrance and/or an exit for inserted pipes, conduits, tubing, or wires. When one or more of the included end apertures 716 are not needed for pipes, conduits, tubing, or wires, the end apertures 716 can be plugged by inserting an end-cap plug 718 into the unused end aperture 716.

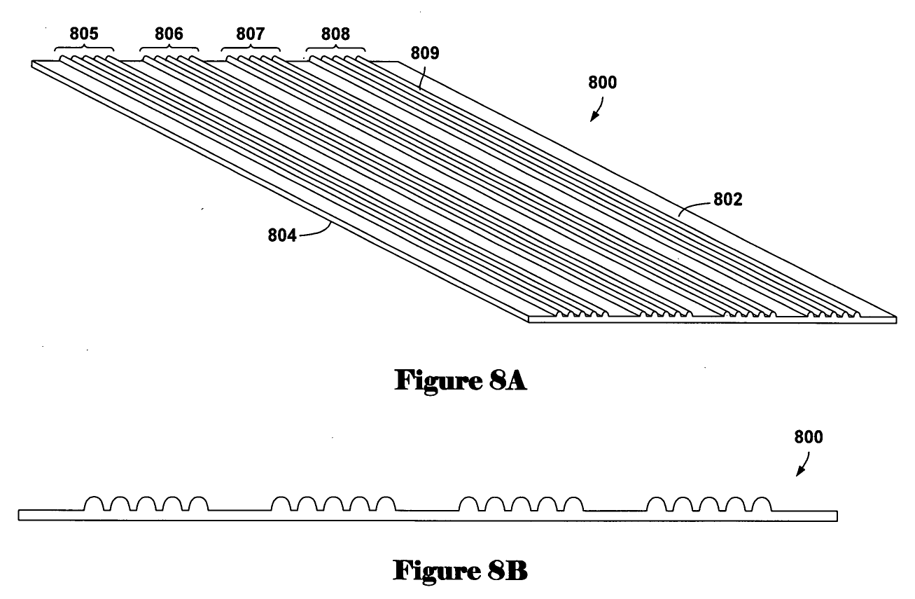

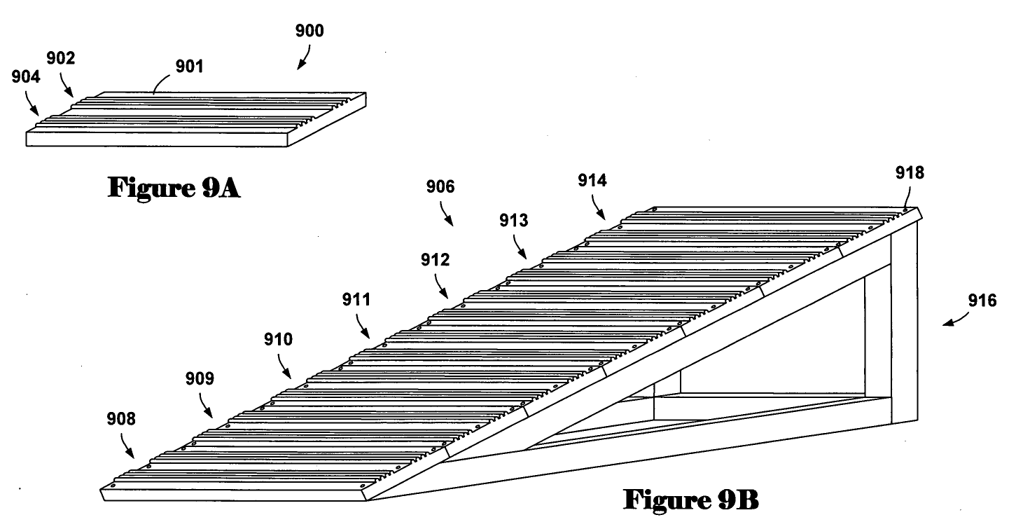

An alternate embodiment of the present invention comprises a slip-resistant, polymer-based sheet. FIG. 8A shows a perspective view of a slip-resistant, polymer-based sheet that represents one embodiment of the present invention. The slip-resistant, polymer-based sheet 800 includes a top 802 and a bottom 804. The top 802 further includes four roughly parallel and roughly evenly-spaced traction-ridge sets 805-808. Each traction-ridge set includes five roughly parallel traction ridges, such as traction ridge 809. FIG. 8B shows an end view of the slip-resistant, polymer-based sheet shown in FIG. 9A that represents one embodiment of the present invention. In FIGS. 8A-8B, the traction ridges extend the length of the slip-resistant, polymer-based sheet 800. In alternate embodiments, traction ridges are also placed on the bottom of the slip-resistant, polymer-based sheet 800.

FIG. 9A illustrates a slip-resistant, polymer-based sheet that represents one embodiment of the present invention. Slip-resistant, polymer-based sheet 900 includes a top 901 that contains two traction-ridge sets 902 and 904, each traction-ridge set having four traction ridges. Various types of floorings and walkways can be constructed by piecing together a number of slip-resistant, polymer-based sheets 900.

FIG. 9B illustrates a ramp constructed using a number of the slip-resistant, polymer-based sheets shown in FIG. 9A and represents one embodiment of the present invention. Ramp 906 includes seven slip-resistant, polymer-based sheets 908-914 abutting one another and mounted to a ramp frame 916. Each slip-resistant, polymer-based sheet 908-914 is interconnected with ramp frame 916 by a number of washers and self-tapping wood screws, such as self-tapping wood screw and washer 918. Traction ridges on slip-resistant, polymer-based sheets 908-914 provide gripping surfaces for increased traction while moving up or down the ramp 906. For example, the traction ridges may prevent a person walking, or rolling in a wheelchair, up or down ramp 906 from sliding. The ramp shown in FIG. 9B can be constructed with slip-resistant, polymer-based planks in addition to, or in combination with, slip-resistant, polymer-based sheets. The slip-resistant, polymer-based sheets can be used with other building materials. For example, ramp frame 916 can be constructed from wood. In alternate embodiments, different types of fastening devices can be utilized to mount slip-resistant, polymer-based structural members to other surfaces. Many different fastening devices, both visible and hidden, are currently available.

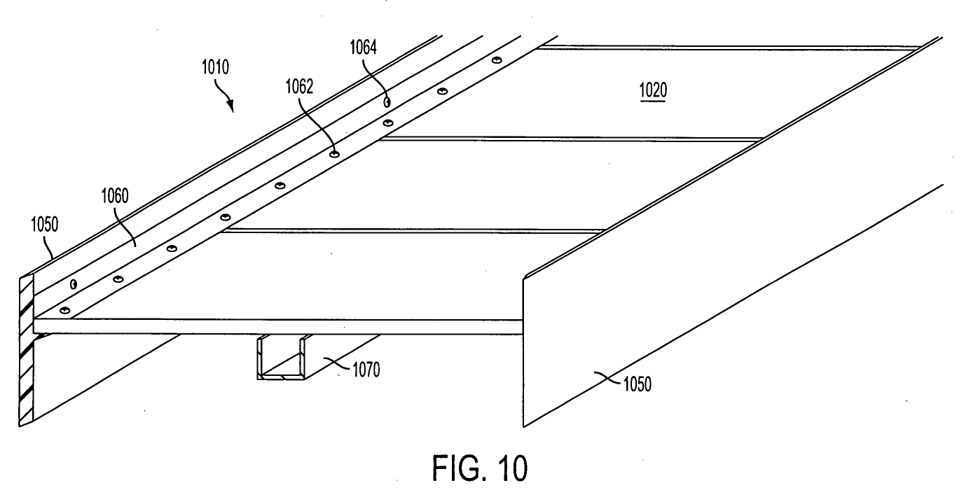

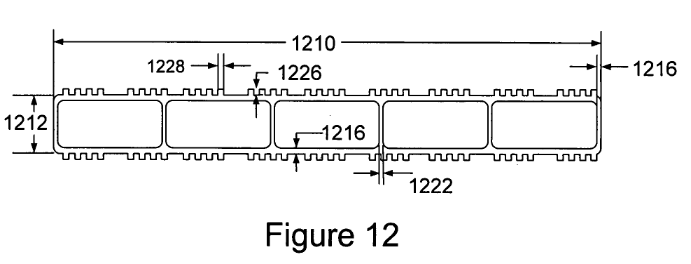

FIG. 10 shows a ramp installation 1010 that has been found to meet ADA requirements for deflection when using the deck elements 1020, which are shown in detail FIG. 12. Each deck element 1020 has a width 1030 of 30.48 cm (1 feet) wide and a length 1040 of 91.4 cm (3 feet). Deck elements 1020 are made of extruded outdoor grade rigid polyvinyl chloride, which may be obtained under the material designator Geon E7130 from PolyOne distribution, which maintains a website having web address www.polyone.com. Elements 1020 are supported by parallel rails 1050, each of which has a lip 1052 that protrudes toward the other rail, by 4.5 cm (1.75 in). Each rail 1050 is made of aluminum that is 0.635 cm thick. On either side, an L-beam 1060 is fastened to lip 1052 by three threaded fasteners 1062, which extends through decking elements 1020. Each L-beam 1060 is 3.2 cm (1.25 in)×3.2 cm (1.25 in) ands is 1.6 mm ( 1/16 inch) thick. The pressure exerted by each L-beam 1060 pressing elements 1020 into lip 1052, on either side, acts to retain elements 1020 and to prevent fasteners 1062 from tearing the walls of elements. 1020. A square tube 1070 extending along the transverse middle of the ramp, supports elements 1020 in their centers. Tube 1070 and rails 1050 are shown in cross-section as the ramp is shown near the end of a frame 1110 (see below), but not at the end of a frame 1110.

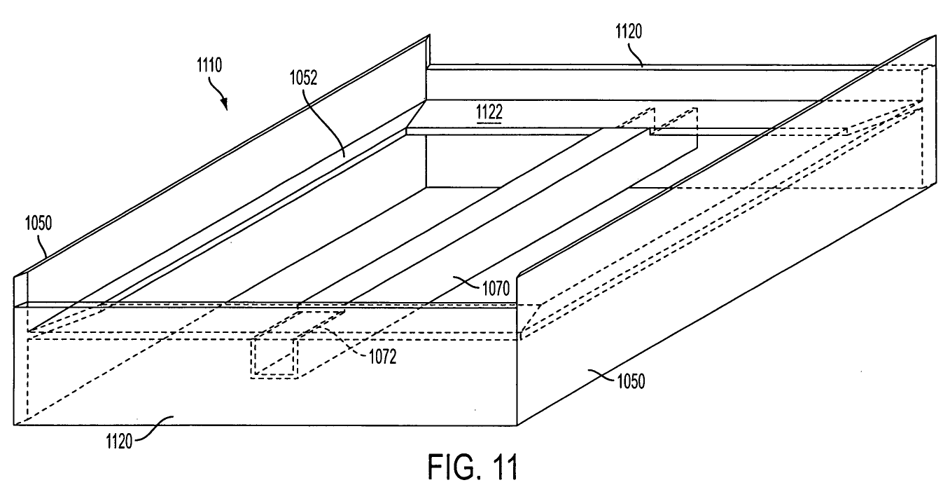

FIG. 11 is a perspective view of a frame 1110, adapted to form a portion of the ramp installation 1110. A pair of end rails 1120, each having a lip 1122, are joined with side rails 1050 to form the rectangular frame 1110. The horizontal tube 1070 has a notch 1072, where it is welded to an end rail lip 1122 on either end, so that the top surface of tube 1070 is flush with the top surface of lip 1122, which is in turn flush with the top surface of each side rail lip 1052. Accordingly, each side rail lip 1052, end rail lip 1122 and the square tube 1070 form an even set of surfaces upon which elements 1020 can rest evenly. It may be noted that the side rails 1050, extend up above the surface of elements 1020, thereby forming a rim to prevent the wheel of a wheelchair from rolling off the edge of ramp 1010. End rails 1120 do not extend up above elements 1020, so as not create a bump in the surface of the ramp 1010.

Referring to FIG. 12, each deck element 1020 has, as noted earlier, a width 1210 of 30.48 cm (12 in) and has a thickness 1212 of 3.8 cm (1.48 in). It is made of an exterior wall 1214 having a thickness 1216 of 3.175 mm (0.125 in) and four interior walls 1220 spaced roughly evenly across the interior of element 1020 and each having a thickness 1222 of 2 mm (0.08 in). The exterior is covered with bumps 1224, each having a height 1226 of 2 mm (0.08 in) and a width 1228 of 3.65 mm (0.1437 in).

This ramp construction has many advantages compared with the current state of the art aluminum ramp deck. PVC is far less reflective than aluminum, thereby creating far less glare. Moreover, the PVC used (see above) has a hardness quantified according to durometer ASTM standard D2240 by the number 81. It is difficult to compare this hardness with that of steel, because steel or aluminum; are so much harder that their hardness is measured by way of a different technique and is stated on a different scale. Steel typically has a diamond pyramid hardness number of greater than 90. The relative softness of PVC avoids the hazard to a person falling upon it that either steel or aluminum creates.

Moreover, deck elements 1020 are far lighter than are the corresponding galvanized steel deck elements, which weigh 29 pounds each and make up 70% of the weight of a typical ramping system. The lower weight of elements 1020 greatly reduces the expense shipping a ramping systems to customers and eases the burden of lifting the decking elements into place during ramp installation. Also, elements 1020 may in any desired color by adding dye to the extrudate during manufacturing. In one preferred embodiment, aluminum support members of the ramping system are powder coated a matching or complimenting color to the color of elements 1020.

Ramps made according to this method can resist a load of 300 lbs over any 2 inch by 2 inch square on the ramp upper surface. The ramp provides a 91.5 cm (3 foot) wide top surface, but could be made wider with wider elements. It appears that there is currently no available ramp having polymeric decking elements and being able to support even a 200 lb load over any 2 inch by 2 inch square, even for a more narrow 80 cm ramp. Moreover, the aforesaid 300 lb load can be supported even when the ambient air temperature is 50 degrees Celsius, which translates to 122 degrees Fahrenheit. The hot temperatures do affect the structural qualities of the polymer used (see above) but even at very hot temperatures, the structure is still strong enough to meet the requirements.

Slip-resistant, polymer-based structural members can be fabricated from extrudable or pultrudable thermoplastic materials. Many commonplace indoor and outdoor grade PVC compounds can be used to fabricate a slip-resistant, polymer-based structural member. Many different fiber, mineral, or chemical additives can be added to the thermoplastic during the extrusion or pultrusion process, including, glass, rice hulls, wood, nut shells, anti-fungal treatments, and other additives. A slip-resistant, polymer-based structural member can also be embossed with a wood grain, or other desired surface treatment, to give the slip-resistant, polymer-based structural member a look more similar to wood, or other desired material. Various nonskid mechanical or chemical coatings can also be added to the polymer. Multi-layering extrusion and pultrusion techniques may be used to increase strength of the polymer.

Slip-resistant, polymer-based planks can be extruded or pultruded into various thicknesses and widths, including two inches by two inches, two inches by four inches, two inches by six inches, two inches by eight inches, two inches by ten inches, two inches by twelve inches, four inches by four inches, and other common structural member sizes. Note that many common structural member sizes, such as two inches by four inches can actually be slightly smaller, such as one-and-three-fourths inches by three-and-a-half inches. Slip-resistant, polymer-based planks can be cut to specific lengths during the extrusion or pultrusion process or anytime thereafter. Likewise, slip-resistant, polymer-based sheets can be extruded or pultruded into various lengths and widths, including four foot by eight foot, four foot by twelve foot, and other commonly-used lengths and widths, and various thicknesses, including half inch, five-eights inch, three quarters inch, and other commonly-used structural member thicknesses.

Slip-resistant, polymer-based structural members have many advantages over other traditional floor and walkway materials, including strength, durability, fire resistance, corrosion resistance, and chemical resistance. Moreover, polymer-based structural members are lightweight, non-conductive, and low maintenance. Slip-resistant, polymer-based structural members can be used for many different flooring applications, including decks, walkways, ramps, steps, staircases, ladder rungs, access steps for boats or trucks, loading platforms, scaffolding, docks, dock ramps, gangways, catwalks, platforms, mezzanines, bridge decks, door thresholds, cooling tower decks, baffle walls, truck beds, bulk heads, machinery guards, landings, and many other floor and walkway surfaces. Moreover slip-resistant, polymer-based structural members can also be used for many different types of access systems, including safety roof walks, handicap ramps, and grandstand wheelchair access areas.

Additional modifications within the spirit of the invention will be apparent to those skilled in the art. For example, traction-providing logos and advertisements can be imprinted on a slip-resistant, polymer-based structural member. The shapes, sizes, and colors of a slip-resistant, polymer-based structural member can be modified. Different thermoplastics can be used to fabricate a slip-resistant, polymer-based structural member. Groupings of interior support walls, exterior traction ridges, and traction-ridge sets can be altered. A slip-resistant, polymer-based structural member can be fastened to various different types of surfaces, including wood, concrete, galvanized steel, aluminum, brick, stone, and other building materials. A slip-resistant, polymer-based structural member can be fastened to different types of surfaces using various techniques, including screws, epoxy, nails, magnets, rope, or other fastening means.

The foregoing detailed description, for purposes of illustration, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Obviously many modifications and variation are possible in view of the above teachings. The embodiments were chosen and described in order to best explain the principles of the invention and its practical applications and to thereby enable others skilled in the art to best utilize the invention and various embodiments with various modifications as are suited to the particular use contemplated.

1. A ramping system for facilitating access to a public accommodation by handicapped persons, comprising:
(a) a support structure adapted to support a set of ramp deck elements leading from a lower surface to an upper surface; and
(b) a set of ramp deck elements made of polymeric material, supported by and rigidly attached to said support structure to create a ramp that extends from said lower surface to said upper surface; and
(c) wherein said ramp deck is at least 80 cm wide and has a top surface and is strong enough to withstand a force of 200 lbs over any 2 inch by 2 inch square on said top surface.

2. The ramping system of claim 1, wherein said ramp deck elements have a width of greater than 80 cm and a mass per length of less than 10 kilograms per meter.

3. The ramping system of claim 1, wherein said ramp deck elements have a top surface that is patterned to provide improved traction.

4. The ramping system of claim 3, wherein said ramp deck elements have a bottom surface that is patterned to permit said ramp elements to be flipped over if said top surface becomes worn, so that said bottom surface becomes a new top surface, and can provide a patterned surface to users.

5. The ramping system of claim 1, wherein said support structure includes two parallel rails, adapted to laterally support said ramp deck elements, which bridge said parallel rails.

6. The ramping system of claim 5, wherein said two parallel rails each have a horizontally lip protruding into space between said rails, and wherein said ramp deck elements are supported on other side by a said lip, to which said ramp deck elements are also fastened.

7. The ramping system of claim 1, wherein said support structure includes aluminum structural elements.

8. The ramping system of claim 1, wherein said ramp deck top surface is capable of supporting a weight of 300 lbs over any 2 inch by 2 inch portion of said ramp deck top surface.

9 The ramping system of claim 8, wherein said ramp can withstand the recited load, even at a temperature of 50 degrees Celsius.

10 . The ramping system of claim 1, wherein said ramp deck is at least 90 cm wide.

11. A method of facilitating construction of a ramping system for providing access to a public accommodation, located in a vicinity, by handicapped persons, comprising:
(a) assembling a ramp construction kit that includes ramp deck elements that are greater than 80 cm wide and have a mass per length of less than 10 kilograms per meter; and
(b) shipping said ramp, by common carrier, to said vicinity of said public accommodation; and
(c) wherein a ramp constructed from said kit can withstand a force of 200 lbs over any 2 inch by 2 inch square on its surface.

12. A ramping system for facilitating access to a public accommodation by handicapped persons, comprising:
(a) a support structure adapted to support a set of ramp deck elements leading from a lower surface to an upper surface; and
(b) a set of ramp deck elements made of material having a diamond pyramid hardness number of less than 130, supported by said support structure to create a ramp that extends from said lower surface to said upper surface and has a ramp top surface; and
(c) wherein said ramp system is capable of withstanding a force of 200 lbs over any 2 inch by 2 inch surface of said ramp top surface.

13. The ramping system of claim 12, wherein said ramp deck elements have a width of greater than 80 cm and a mass per length of less than 10 kilograms per meter.

14. The ramping system of claim 12, wherein said ramp deck elements have a top surface that is roughened to provide improved traction.

15. The ramping system of claim 14, wherein said ramp deck elements have a bottom surface that is roughened to permit said ramp elements to be flipped over if said top surface becomes worn, so that said bottom surface becomes a new top surface, and can provide a roughened surface to users.

16. The ramping system of claim 12, wherein said support structure includes two parallel rails, adapted to laterally support said ramp deck elements, which bridge said parallel rails.

17. The ramping system of claim 16, wherein a top longitudinal element is fastened through apertures in said ramp deck elements to each of said two parallel rails.

18. The ramping system of claim 12, wherein said ramp top surface is able to withstand a load of 300 lbs over any 2 inch by 2 inch square of top surface area.

19. The ramping system of claim 12, wherein said ramp top surface area is able to withstand said load, even at a temperature of 50 degrees Celsius.
